(19) United States
(12) Patent Application Publication
(10) Pub. No.: US 2007/0022196 A1
(43) Pub. Date: Jan. 25, 2007

(54) Single token multifactor authentication system and method

(76) Inventor: Subodh Agrawal, Plano, TX (US)

Correspondence Address: Alan R. Thiele;Strasburger & Price, LLP, Suite 4400, 901 Main St., Dallas, TX, 75202, US

(21) Appl. No.: 11/477,051

(22) Filed: Jun. 28, 2006

Related U.S. Application Data
(60) Provisional application No. 60/695,059, filed on Jun. 29, 2005.

(51) Int. Cl. G06F 15/173

(52) U.S. Cl. 709/225

(57) ABSTRACT

A system and method for using multiple factors to verify and thereby authenticate the identity of a user attempting to gain access to a personal account at an on-line service provider. The disclosed system and method may be used by multiple on-line service providers thereby enabling the user to be in possession of a single set of identification factors to gain access to one of multiple accounts. Once the user provides the proper identification factors and the identification factors are verified by matching them against factors stored in a computer, the identity of the user is deemed to be authentic and the user is passed onto the on-line service provider for access to the user's personal account.

This application claims the benefit of U.S. Provisional Patent Application No. 60/695,059 filed Jun. 29, 2005.

### STATEMENT REGARDING FEDERALLY SPONSORED RESEARCH OR DEVELOPMENT

The invention described in the instant application was not the subject of federally sponsored research or development.

### FIELD

The present invention pertains to security authentication systems; more particularly, the present invention pertains to security authentication systems usable with service providers who provide remote access to user accounts on-line, such as banks, health service providers, government agencies and the like.

### BACKGROUND

In studies by various research groups, the problem of attackers gaining access to the websites of financial services providers by stealing passwords from legitimate customers was recognized as a serious threat to the security of personal accounts at financial institutions. In addition, the Federal Financial Institutions Examination Council (FFIEC) has emphasized the growing importance of the need to implement a solution to the problem of a potential attack on a financial services website.

One of the ways that financial service providers have approached the problem of blocking unauthorized access to websites is by the use of a small physical token carried by a user or an account holder. The physical token acts as a key by which a user can gain access to the information in an otherwise locked account maintained by the on-line service provider. Such physical tokens are offered by several manufacturers and are actually time controlled random number generators. Most physical tokens also include an identification number or a serial number on the case. The identification number or the serial number is associated to a user identification record which is stored in a database. A static password or a personal identification number (PIN) is also normally associated to an individual physical token.

When the user identification information or the identification of the serial number on the case of the physical token is entered into the website of an on-line service provider, the website then queries the user to provide the assigned static password or a PIN followed by the random number appearing on the physical token at that time. When the user enters the static password or the PIN followed by the random number generated on the physical token into the website of the on-line service provider, the static password and the random number combination as entered on the web-site of the on-line service provider is sent to an authentication system at the on-line service provider where the random number appearing on the physical token is matched with a time controlled random number supplied separately to the memory of the computer.

In prior art personal account security systems each on-line service provider has their own authentication system to receive, check out and respond to one attempting to gain access to an account. When the combination of the of static password associated with the physical token and the random number appearing on the physical token match with the authentication system of the on-line service provider at a point in time, the user is verified as an authorized user. Such random numbers change at various time intervals from less than a minute to more than several minutes depending on the manufacturer and the type of the physical token. Generally, the same information can be used repetitively as long as the random number does not change on the physical token and/or computer application/memory.

According to the current state of the art, a different physical token must be used to gain access to an account at each financial service institution. As indicated above, each on-line service provider operates their own authentication system for receiving, checking out and responding to one attempting to gain access to an account. For example, if a user has six accounts, the user will need to carry six tokens. While the physical tokens are designed to be the size of a fob for placement on a user's key ring, multiple physical tokens needed for access to multiple accounts at multiple financial institutions quickly become inconvenient for a user to carry. Such prior art system is illustrated in FIG. 1. Therein, the user 100 has six accounts 101-106 and therefore must carry six tokens 111-116, as each physical token provides the security pathway by which a user can gain access to the authentication system at each on-line service provider before the user can gain access to his/her personal account.

Accordingly, there remains a need in the art for a system and method which addresses the problems of making it more difficult for attackers to gain access to the personal accounts of a user at a financial institution or other similar institutions where user accounts are maintained, and at the same time not burdening users with the inconvenience of having to carrying multiple physical tokens for gaining access to multiple accounts with multiple on-line service providers. Further, there remains a need in the art for a system and method which will enhance security for account holders at on-line service providers at a lower cost to on-line service providers by eliminating the need for each on-line service provider to build, operate and maintain its own multifactor authentication system to provide adequate security to safeguard the personal account of a user.

### SUMMARY

The disclosed system and method of the present invention creates additional difficulty for attackers to gain access to a user's account by requiring multi-factor authentication while at the same time not burdening users with the inconvenience of having to carry multiple devices for gaining access to multiple personal accounts with multiple on-line service providers. Further, the disclosed system and method reduces costs for on-line service providers by eliminating the need for each on-line service provider where a user has a personal account to build, operate and maintain its own authentication system to protect users who desire to gain access to their personal accounts.

While the disclosed system and method will be described in terms of the use of a physical token in the physical possession of an account holder at an on-line service provider, those of ordinary skill in the art will understand that the disclosed multi-factor authentication system and method is applicable to any multifactor authentication system providing security for users' accounts at on-line service providers. For example, instead of a physical token to provide identification factors, other systems used to provide multifactor authentication for account holders at on-line service providers such as biometric, software tokens, smart cards, public key authentication and the like may be used in place of a physical token.

The disclosed system and method provides for multi-factor authentication of the identity of a user of one of multiple on-line services through the integration and consolidation of the security authentication needs of multiple on-line service providers at one location. According to the disclosed system and method the user carries a single physical token and by using the single physical token and an additional item such as a password, the identity of the user will be authenticated. Such authentication will allow the user to first gain access to the on-line service provider website where the user may then be asked for additional security related information by the on-line service provider before access is gained to a user's personal account.

While a user desiring to gain access to information in a personal account enters the on-line service provider's website to view an account record or effect a transaction in the personal account, the user never perceives leaving the on-line service provider's website because the multi-factor authentication system of the present invention is maintained separately and apart from the on-line authentication system of the service provider and is thereby invisible to the user.

Specifically, when the user approaches a computer terminal to gain remote access to a personal account at an on-line service provider, the user will see a screen asking for log-on credential information. The responses provided to the requests for log-on credential information will be fed through a client infrastructure to an authentication infrastructure. Each of the client infrastructure and the authentication infrastructure are built around one or more computer servers and one or more data bases. When the requested multi-factor information is provided by the user, the system and method of the present invention will match the multi-factor information to the information about the user stored in the one or more data bases in the client infrastructure and the authentication infrastructure to allow the user to be connected to those screens on the website of the on-line service provider which lead to access to a user's personal account.

If the requested multi-factor information obtained from the user does not match the information stored in the data bases in the client infrastructure and the authentication infrastructure, the user will not be granted access to further screens established by the on-line service provider which would eventually lead to access to the user's personal account.

Because the system and method of the present invention enables a single token to be mapped to multiple on-line service providers, the user need only know one set of first identification factors and possess one set of second identification factors and log in one time to gain access to each personal account at each one of a set of selected on-line service providers.

In operation, the system and method of the present invention envisions that an authorized user with a physical token having an identification number will be using a remote computer terminal to gain access to a personal account at an on-line service provider that has adopted the system and method of the present invention. A user ID and a static password combined with the set of random numbers generated by the physical token will be entered at the remote computer terminal. The mapped user ID and/or information about the physical token and the combination of a static password and the numbers appearing on the physical token with other information will be transmitted by the application server in the client infrastructure to the authentication server in the authentication infrastructure where the mapped user ID, token information, and combination of password and numbers from the physical token will be verified. Once verified, the on-line service provider will be notified of the authentication status of the user.

For valid authenticated users, the on-line serve provider will grant access to the user's personal account at the on-line service provider and for invalid users the on-line service provider will deny the access and ask the users to provide the log-on credentials again. The system and method of the present invention may also be used to permit a customer service representative of an on-line service provider to identify a user calling in for service to a personal account and thereby allow the user to view the user's personal account and thereby gain access to the requested services. In this case, the customer service representative of the on-line service provider will ask the user for information from the physical token and the random number which appears on the physical token. Then the on-line service provider will respond by providing the user information on the on-line service provider's customer support application. The client infrastructure will then send a request for a random number as it appears on the physical token. The authentication infrastructure will provide the random number as it should appear on the physical token at that point in time. Once the numbers are found to match, the client service representative of the on-line service provider can confirm the authentication of the user calling in for access to his/her personal account.

The disclosed system and method also includes procedures by which users not in possession of a physical token may obtain a physical token. If a user does not have a physical token and is not a participant in the disclosed system, the user is offered a procedure to obtain a physical token and enroll in the disclosed system. Alternatively, if the user has a physical token and is enrolled as a user of the disclosed system and method, procedures are offered wherein the user can map the token to additional on-line service providers. In the case of a lost or damaged physical token, an alternative method using a default password is provided to allow the user to gain access to a personal account.

### BRIEF DESCRIPTION OF THE DRAWING FIGURES

A still better understanding of the single token, multi-factor authentication system and method of the present invention may be had by reference to the drawing figures wherein:

FIG. 1 is a schematic view of the prior art method of securing and gaining access to user accounts using the websites of multiple on-line service providers;

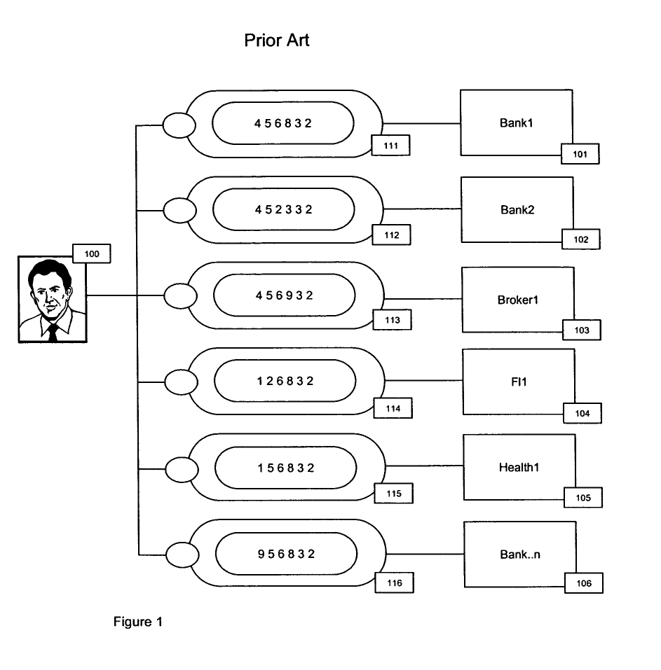

FIG. 2 is a schematic view of the disclosed system and method for multi-factor authentication using a single token before gaining access to user accounts at multiple on-line service providers;

FIG. 3A is a view of an exemplary screen observed by a user of the disclosed system and method;

FIG. 3B is a more detailed schematic view of the arrangement of the various major components required to enable the disclosed multi-factor authentication system and method to operate;

FIG. 4 is a schematic diagram of a flow chart of the disclosed multi-factor authentication process;

FIG. 5 is a schematic diagram of the enrollment process of the disclosed system for a user with the on-line service provider;

FIG. 6 is a schematic diagram of the process which occurs when the request by a user to activate a physical token is in a pending status;

FIG. 7 is a schematic diagram of the enrollment process for a user when the user elects to enroll in the system and method of the present invention as a new user to the authentication system or an existing user where the user wants to map his/her existing token with the on-line service provider;

FIG. 8 is a schematic diagram of the processing of the validation of information entered by a user for authentication;

FIG. 9 is a schematic diagram of the physical token authentication system, user id and/or token validation process during enrollment of the user with the on-line service provider where the user is already a user within the disclosed multi-factor authentication system and method and wants to map his/her token with a new on-line service provider;

FIG. 10 is a schematic diagram of the processing of an enrollment request by the authentication infrastructure; and

FIG. 11 is a schematic diagram of the process of providing a new physical token when a physical token has been lost or damaged.

### DESCRIPTION OF THE EMBODIMENTS

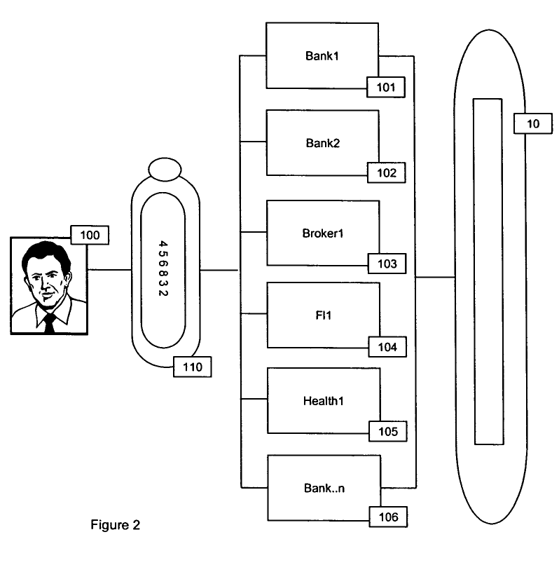

The disclosed multi-factor authentication system and method 10 is best understood by an overview of the enabled functionality as seen in FIG. 2. Those who access the services of on-line service providers 101-106 know that such access can be obtained at a variety of remote locations provided a link is established between the computer terminal at which the user 100 is located and each on-line service provider 101-106. According to the disclosed system and method 10, the user 100 approaches the computer terminal where access to a personal account maintained by the on-line service provider is to be gained.

To use the multi-factor authentication system and method 10 of the present invention, the various on-line service providers 101-106 will add the system and method 10 of the present invention to their security pathway for entering a personal account maintained and serviced by the on-line service provider 101-106.

As indicated above, while the disclosed multi-factor authentication system and method 10 is described with reference to its use with a physical token, other systems which provide identifying factors may be used with the system and method of the present invention. For example, other identifying factors obtained from biometrics (fingerprints, eyeprints, etc.), software tokens, smart cards, public key authentication and the like are all usable in conjunction with the disclosed system and method 10.

As shown in FIG. 2, the user 100 is able, with a single physical token 110 and a password, to access one or more on-line service providers 101-106 from an array of on-line service providers as symbolized by the boxes 101, 102, 103, 104, 105, and 106. Each of the on-line service providers has included the system and method 10 of the present invention in its own security pathway to minimize the vulnerability of the user's personal account to an attack by an unauthorized person. At the same time the user 100 is provided the convenience of needing only one token to access personal accounts at multiple on-line service providers. The on-line service provider may ask the users to provide a user id, a password, and a My2Pin combination (My2Pin composed of a static number (hereinafter “PIN”) and the random number appearing on the physical token as the second factor from the token) or just a user id and a My2Pin combination for authentication once the user status is set to A in a custom table (described below) resident in a data base 16 attached to the application server 14, signifying an active user. Once the user has provided the requested set of identification factors and the identity of the user has been verified by the system and method 10 of the present invention, the on-line service provider has the option of requesting yet additional identifying information from the user for use in the on-line service provider's internal security system.

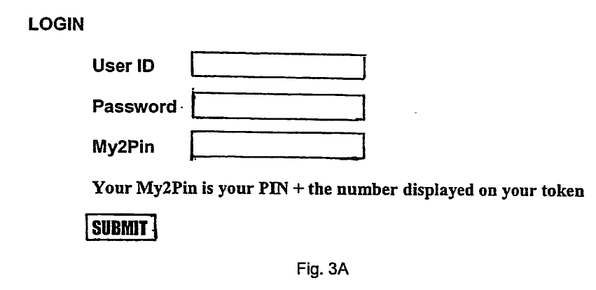

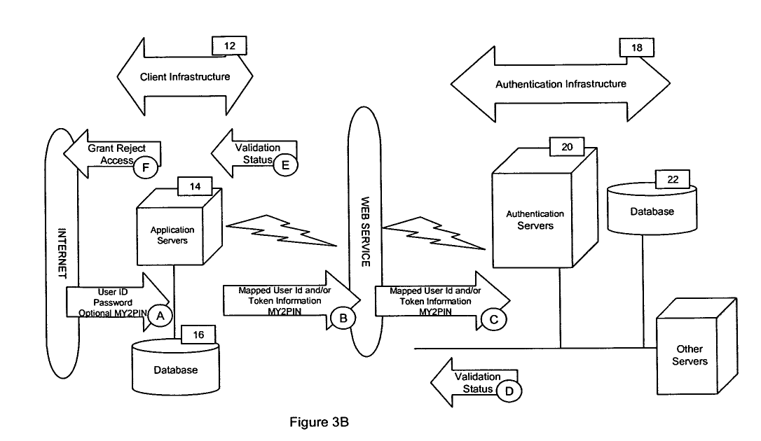

All the user 100 knows is that a user id, an optional password (depending on the service provider), a static PIN, and the number appearing on the physical token is needed to gain access to any one of the user's personal accounts at multiple on-line service providers 101-106. To effect the disclosed system and method 10, those of ordinary skill in the art will understand that the information which is entered at what is termed herein as the My2Pin portion of a user screen appearing on a computer terminal by a user must then be mapped to one or more of a set of desired on-line service providers. An example of one type of such a screen appears at FIG. 3A.

Once the system and method 10 of the present invention verifies that the information provided by the user 100 at the My2Pin portion of a screen at a computer terminal provides the necessary log-on credentials or authenticating information, access to selected on-line service provider is granted by the on-line service provider. A user can open another browser window to access his/her account with another on-line service provider. However, a fresh set of log-on credentials will be required for authentication using the system and method 10 of the present invention.

A still better understanding of the disclosed system and method 10 may be had by reference to FIG. 3B. As shown in FIG. 3B, the user approaches a computer terminal and enters the information requested, A, on the screen. As shown in FIG. 3A, this information is a USER ID, an optional password after service activation, and what has been referred to as a My2Pin combination. The My2Pin combination is the combination of a static PIN and a random number displayed on a physical token. The static PIN becomes the first identification factor known to the user and the random number generated by the physical token becomes the second identification factor that the user possesses. The user ID together with the optional password (depending on the service provider) and the My2Pin combination are transmitted from the remote computer terminal, typically over the internet, into a client infrastructure 12. Next, the bits of information including a mapped user id and/or information about the physical token and the My2Pin combination are then sent, B, from the client infrastructure 12 to one or more authentication servers 20 and one or more data bases 22 in an authentication infrastructure 18 using webservice hosted by the authentication infrastructure 18. The one or more authentication servers 20 and one or more data bases 22 in the authentication infrastructure 18 then match the information received from the client infrastructure, C, to information within the data base 22, authentication applications and the application servers 14. After the information is verified, a message, D, with the validation status of the user as shown in FIG. 3B is returned to the webservice that in turn provides the validation status message, E, back to the application server 14 in the client infrastructure 12 that performs additional validation depending on the validation status value to notify the user that access to the on-line service provider has or has not been granted, F.

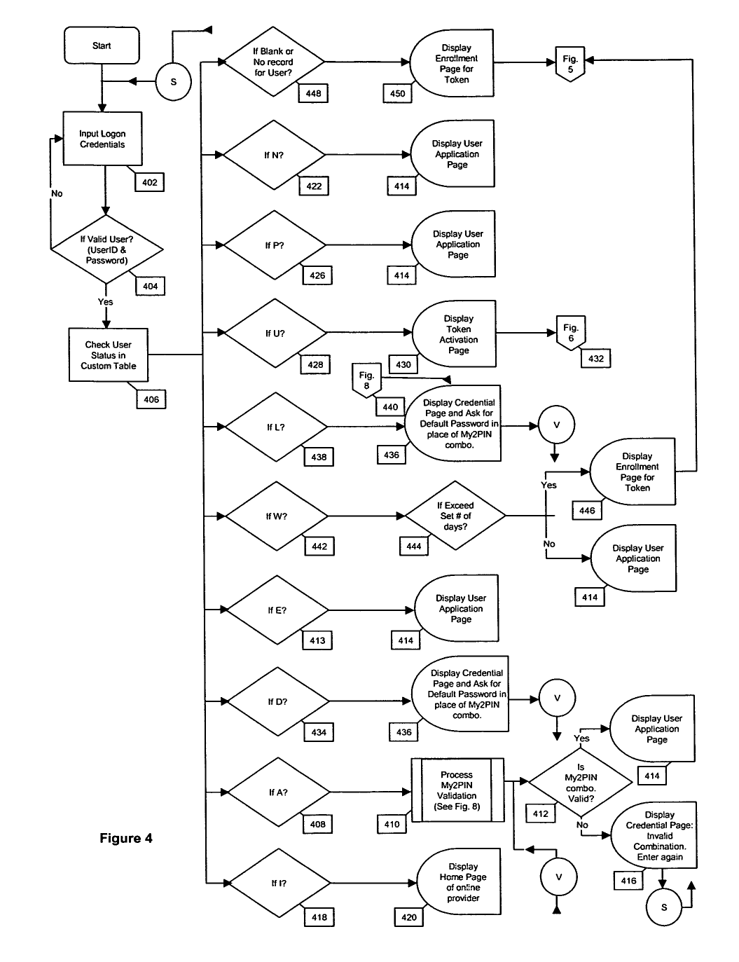

A still better understanding of the system and method 10 of the present invention may be had by reference to the flow chart at FIG. 4.

Beginning with the simplest example, an authorized user with a valid token 110 desires to gain access to a personal account at the on-line service provider by logging onto the website of the on-line service provider at a remote computer terminal. Once logged onto the website of the on-line service provider, the user observes the screen at FIG. 3A. This screen is normally a sub-portion of the on-line service provider's homepage where user can provide the log-on credentials to gain access to his/her account with the on-line service provider. The user first enters his/her log-on credentials: a user ID and optionally password information 402. The application server 14 checks the status 404 of the user in a custom table 406 resident in data base 16 in the client infrastructure 12 then asks for the My2Pin combination if the status of the user is A or active in the custom table or D for damaged token or L for lost token, as explained below. The importance, the structure and the organization of the custom table will also be explained below.

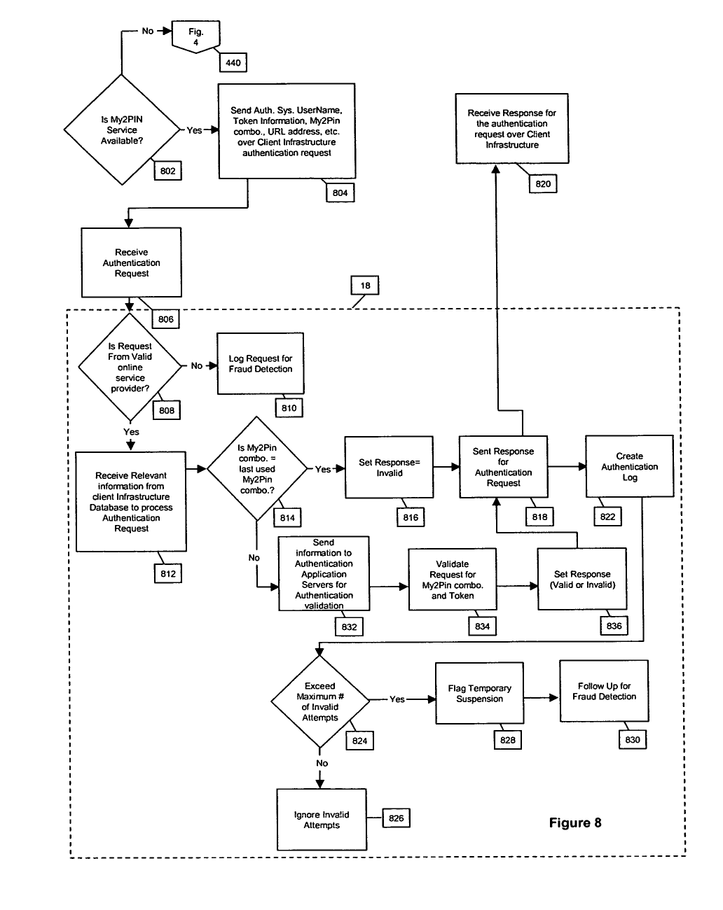

If the status of the user is that of an active participant 408, that is an A is recorded in the status field of the custom table, the user will be asked to enter the My2Pin combination (a Static PIN followed by the random number displayed on the physical token 110 in the user's possession) and pass the validation using the on-line service provider's validation process at on-line service providers 410 and the authentication infrastructure 18, to gain access to his/her personal account. The request for the validation of the My2Pin combination is passed to the authentication servers 20 in the authentication infrastructure 18 where the request goes through a process as described in FIG. 8 and a determination is made if the validation request consisting of the mapped user ID and/or information regarding the physical token and the My2Pin combination (static PIN followed by the random number displayed on the physical token 110) is valid as described below in step 834 FIG. 8.

To provide access to the user at a remote terminal with proper authentication within the disclosed system, some or all of the information is provided 804 by the client infrastructure 12 including:
the authentication system's assigned user name;
information about the physical token;
the My2Pin combination;
the on-line service provider's web address;
other supporting information for secured communication to handle the validation request and the response thereto.

Once the requested information has been received 806 by the authentication infrastructure 18, the determination is made if the validation request being received from an on-line service provider authorized to use the system and method 10 of the present invention 808. If the request is being received from an on-line service provider who is not authorized to use the system and method 10 of the present invention, then the validation request is logged as part of a fraud detection record 810. If, however, the request is being received from an on-line service provider who is authorized to use the system and method 10 of the present invention, processing of the information flow continues 812 by determining 814 if the My2Pin combination for the user received for validation is the same as the last My2Pin combination received for the user. If the answer to this question is yes, a response is set as being invalid 816 and the response is sent for an authentication request 818 back to the client infrastructure 820. This is done to assure that the My2Pin combination (combination of the static PIN and the random number) can be used only once to provide enhanced security. Further, an authentication log is created 822. The number of entry attempts into the system is then recorded and compared to a predetermined number 824. If a predetermined maximum number of invalid attempts has not been exceeded, the prior invalid attempts are ignored. But, it the predetermined number of invalid attempts has been exceeded, then a flag is generated temporarily suspending 828 the authentication request and generating a follow-up for the detection of fraud 830.

If the user id and information about the physical token combined with the My2Pin combination (static PIN and random number from the physical token) does not equate 814 to the last My2Pin combination (static PIN and random number from the physical token) used, this information is sent to the application server 14 for authentication validation 832. Herein the request for a My2Pin combination and information about the physical token is validated 834. The response is established as being valid or invalid 836 and processed as described above by the sending of a response to an authentication request 818.

Further, as shown in FIG. 8 response to the authentication request 818 is sent by the authentication infrastructure 18 to the client infrastructure 12. In the client infrastructure 12, a determination is made 412 (FIG. 4) if the response is a successful validation or an error. If the user is an active participant in the system and method 10 of the present invention and the log-on credentials entered by the user are successfully validated, the user then observes the user application page 414 on successful authentication. The user application page is what the user views after successfully logging into the website of the on-line service provider. At this website, the user may be granted direct access to an account or may be required to enter yet additional security information requested by the individual on-line service provider.

If the log-on credentials entered by the user are not successfully validated, the user is required to provide the log-on credentials including the My2Pin combination again 402. If the combination of the user ID, and the combination of static PIN and the random number displayed on the physical token 110 do not check out as being valid, such as when an error has been made typing in the My2Pin combination or an attacker is trying to gain unauthorized access to a user's account, the user will be sent back 416 to the log-on credential page 402 (see letter S in FIG. 4). If the new log-on credentials check out as being valid, the user will be granted access to the user application page on the website of the on-line service provider. On successful validation of the log-on credentials including the My2Pin combination, the user application page 414 will be displayed.

If a user has a physical token but is determined to be an inactive user 418, status I in the custom table described below, the home page of the on-line service provider will be shown to the user 420. Such situation may occur when the user has closed an account with an on-line service provider in the system and method 10 of the present invention.

If the user is a new user and has applied for and not yet received a physical token then a check of the user status in the custom table 406 will reveal that the user has been assigned one of three possible status assignments. These status assignments are described in greater detail below.

The first status is when a new token has been applied for 422, status N in the custom table. In this situation, the user is sent back to the user application page 414 on successful validation of the userid/password combination 404 requested by the on-line service provider using their own existing authentication infrastructure 12. If the user has been assigned an in process status 426, status P in the custom table, the user is sent to the user application page 414 on successful validation of the user id/password combination 404 requested by the on-line service provider using their own existing internal security system.

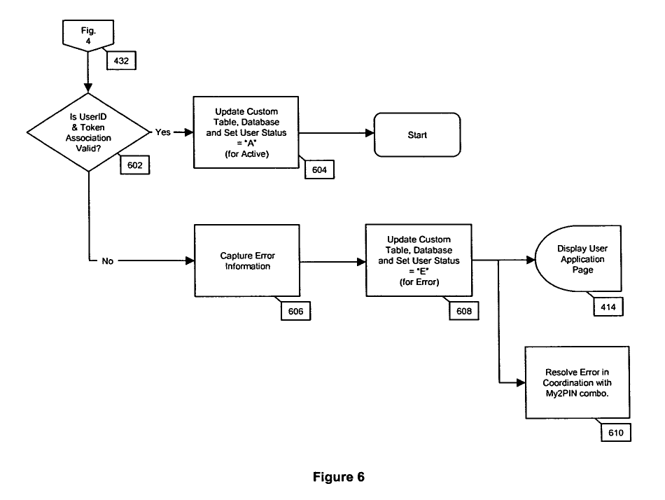

If the activation of the user has been assigned a pending status 428, status U in the custom table, the system displays a token activation page 430 and provides a link 432 to the process illustrated in FIG. 6.

As shown in FIG. 6, beginning with a link 432 back to FIG. 4, a determination is first made that the user ID and token association to the user is valid 602. If the user ID and association of the token to the user is valid, then a notation is made in the custom table and the user is determined to be an active user 604 and the status of the user is set to A or active in the custom table. Next, the request for entry into the user's account is processed as described above. If the user ID and association of the user to the token are determined to be invalid, a notation is made in the custom table and the user is determined to be in an Error Status, status E in the custom table. The user has the option of providing the details of the error in an error box. The error information is captured 606, the custom table is updated 608 to put an E in the field for user status in the custom table. The user is then sent to the user application page 414 of the on-line service provider on successful validation of the user id/password combination 404 requested by the on-line service providers using their own existing authentication infrastructure. The error is resolved manually 610 in coordination with on-line service provider, user and the authentication infrastructure provider.

If the user status has been set 608 to E as shown in FIG. 6 when the user enters log on credentials 402, as shown in FIG. 4, and the user status is E in the custom table 413, on successful validation of log-on credentials 404 the user will be granted access to the user application page 414 and the validation request for My2Pin combination will not be sent to the authentication infrastructure 18.

Again referring to FIG. 4, if the user has a valid token but if the token has become damaged 434, and the user status is set to D in the custom table, the user credential page is displayed and the user is asked for a default password 436 to be used in place of the My2Pin combination. The acceptance of the default password in place of My2Pin combination and successful validation 412 will allow the user to continue the process of logging into the on-line service provider. Specifically, the user will then be treated as a registered user within the system and on-line service provider and passed on to step 412 to determine if the default password in place of My2Pin combination is valid to grant access (see letter V in FIG. 4).

If the user has a valid token 110 but loses the valid token 438, and the user status is set to L in the custom table in the client infrastructure, as shown in FIG. 4, the processing is similar to that of a damaged token as described in the preceding paragraph.

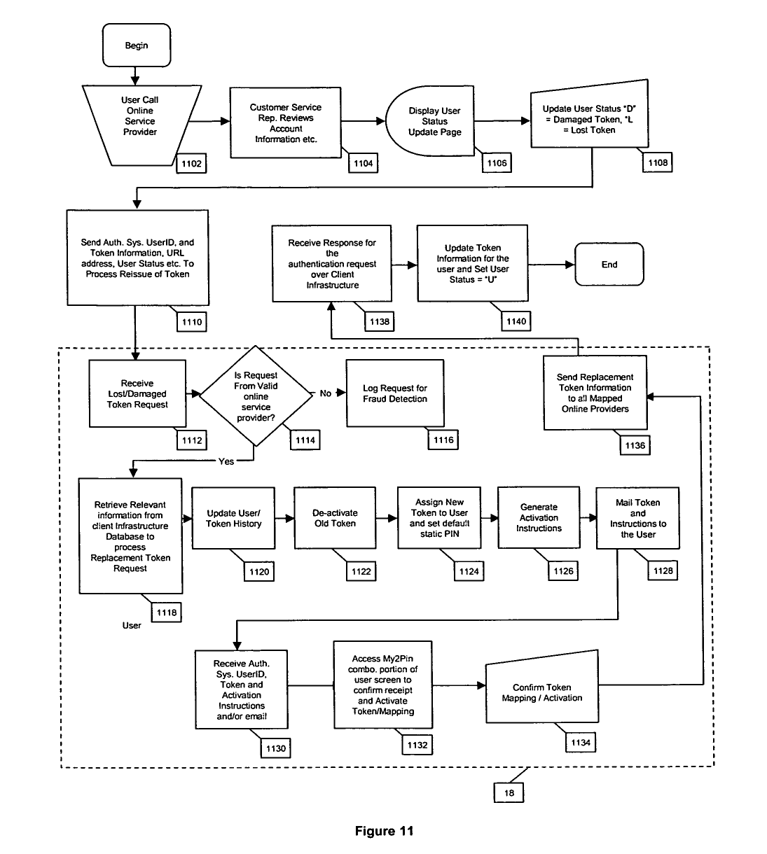

Referring again to FIG. 4, when a user has a damaged token, status D in the custom table 434, or discovers that his/her physical token has been lost, status L in the custom table, the situation is rectified as shown in FIG. 11.

As shown in FIG. 11, the processing begins by the user calling the on-line service provider 1102. An on-line service provider customer service representative reviews the account information of the user 1104 and a user status update information request page is displayed to the customer service representative 1106. The customer service representative, after reviewing the users information and confirming the users identity, updates the appropriate information which is combined with other information about the user. The user's status in the custom table is changed 1108 to either D or L as appropriate for damaged or lost token. The information entered by the customer service representative is combined with other information about the user and the token and sent 1110 to the authentication infrastructure 18. Once the data is received 1112 by the authentication infrastructure 18, it is first determined if the request is coming from an on-line service provider who is authorized to use the system and method 10 of the present invention. If it turns out that the request is coming from an on-line service provider that is not an authorized user of the system and method 10 of the present invention, a log entry is made for fraud detection 1116.

If the request is coming from an on-line service provider authorized to use the system and method 10 of the present invention, then additional information is retrieved 1118 from the data base 22 in the authentication infrastructure 18 to update the history of the user and use of the token 1120.

Because the old token has been lost or damaged, the old token is deactivated 1122. Next a new token is assigned to the user and a default static PIN is set 1124. Activation instructions for the new token are then generated 1126 and a replacement physical token and the activation instructions for the replacement physical token are sent to the user 1128 by independent mail to provide additional security. On receipt of the new token 1130 the user learns his/her updated account information with the authentication infrastructure and confirms receipt and activation of the new token 1134 at the authentication infrastructure 18. The authentication infrastructure then sends the updated token information 1136 to all the other registered on-line service providers for the user. The on-line service provider's infrastructure 12 receives the information 1138 and updates the token details for the user and sets the user status to U in the custom table 1140 in the client infrastructure 12. Once the user status is set to U, the login process will follow the activation and validation steps as outlined above in the disclosed system and method 10. Confirmation 1134 of the mapping of the new token to the additional on-line service providers to which the lost/damaged token was previously mapped begins by sending out information regarding the replaced token 1136. Once this information is received 1138, the user status in the custom table is updated to U for “pending” in the custom table 1140 as described above in the client infrastructure.

If the user has an operating physical token and would like to use the same physical token for additional on-line service providers for multifactor authentication using the disclosed system and method 10, the user will provide 734 information about the physical token and the default password and other information. The default password is stored in the client infrastructure database 16 in the custom table to validate the user and provide access by the on-line service provider to the user's account in case the authentication infrastructure is temporarily unavailable or if the user status is set to D or L for damaged or lost token.

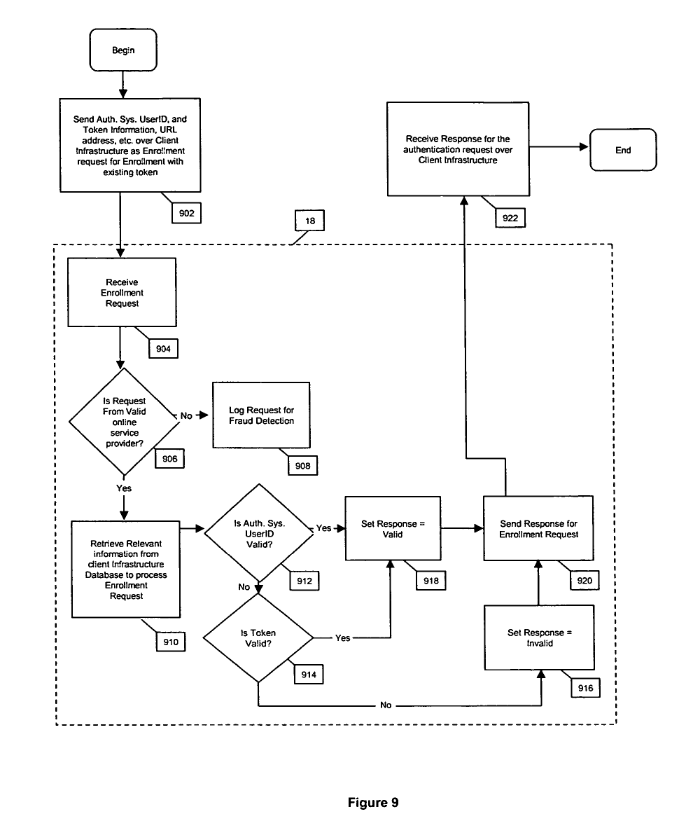

If the user has an operating physical token which is not authorized for use with the system and method 10 of the present invention for the on-line provider, the request to use that token with the system and method 10 of the present invention is processed as described in FIG. 9; that is, the detailed flow chart for step 736.

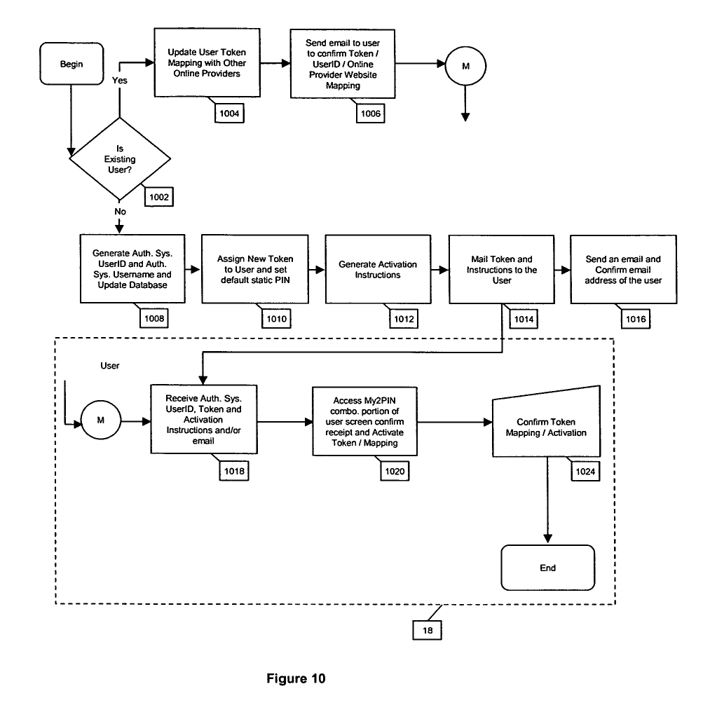

As may be seen in FIG. 9, information about the token in the user's possession is entered 734 by the currently unauthorized user and sent 902 to the authentication infrastructure 18 as an enrollment request validation. Once the enrollment request has been received 904 by the authentication infrastructure 18, the first determination is whether the request is being received from an on-line service provider authorized to use the system and method 10 of the present invention 906. If not, a fraud detection log entry is made 908. If, however, the request is being received from an on-line service provider authorized to use the system and method 10 of the present invention, then a determination is made if the user ID is valid 912. If the user ID is valid, the response is set to valid 918 and an instruction is made to send an enrollment request 920. This request is received 922 by the client infrastructure 12. If the user ID is determined to be invalid, a determination is made if the information received describing the physical token is valid 914. If the information about the token is not valid, the response is set to invalid 916 and the enrollment request is processed by sending a response 920 to the client infrastructure 12 where the response for the authentication request is received 922. If, however, the token is determined to be valid, the response is set to valid 918, and the request is processed as described above in steps 920, 922. Once validated 738 the enrollment request userid and/or information about the physical token, a unique transaction control number also called unique mapping ID is generated within client infrastructure 12 and the custom table is populated with the user details. This information is sent 720 against the unique Mapping ID to the authentication infrastructure 18 to update the user information within the authentication infrastructure. Next the information is received 722 by the authentication infrastructure and the process of enrollment 724 as explained in FIG. 10 is performed in the authentication infrastructure.

To enroll a new user or to update the enrollment mapping for an existing user, the processes as shown in FIG. 10 are performed within the authentication infrastructure 18. As shown in FIG. 10, a determination is first made if the user making the request is an existing user 1002. If the user is an existing user, the mapping to the user's token is updated 1004 using information from other on-line service providers to register new mapping with an existing physical token. This mapping is confirmed to the user who receives information about the updated mapping and a series of three activation steps 1018, 1020 and 1024 are begun (see M in FIG. 10). Specifically, the user receives his/her new user ID, along with the activation instructions 1018 and the mapping information. Then, by accessing the system and method 10 of the present invention, the user confirms receipt of the physical token and activation of the mapping of the physical token to the various on-line service providers is initiated 1020. The user confirms activation of the physical token and the mapping of the physical token for the various on-line service providers 1024. Once activated on the authentication infrastructure 18, authentication infrastructure 18 sends 726 the mapped userid, information about the physical token and other relevant details against the unique mapping id to the on-line service provider to update the custom table and set the user status to U as activation pending on the client infrastructure.

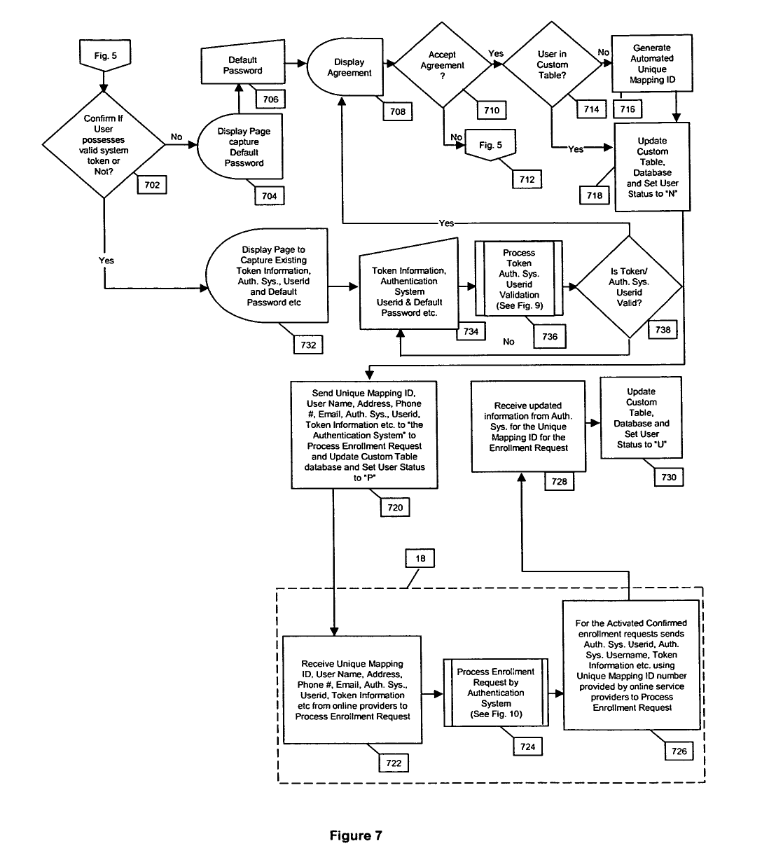

If the requestor is not an existing user in the authentication infrastructure 18, a new authentication system identification number (described below) and authentication system user name (described below) is generated 1008. A new physical token is assigned to the user and a default static PIN is set 1010. The default static PIN can be updated by the user once the token is activated on the authentication infrastructure. Activation instructions are then generated 1012 and the physical token and the activation instructions are sent to the user 1014. The physical token and the instructions for its use are sent in separate mail to enhance security. The activation sequence 1018, 1020 and 1024 as described above is then begun. Once activated on the authentication infrastructure 18, authentication infrastructure 18 sends the mapped userid, information about the physical token and other relevant details against the unique mapping id to the on-line service provider, as shown in step 726 of FIG. 7, to update the custom table within client infrastructure 12 and set the user status as U for activation pending.

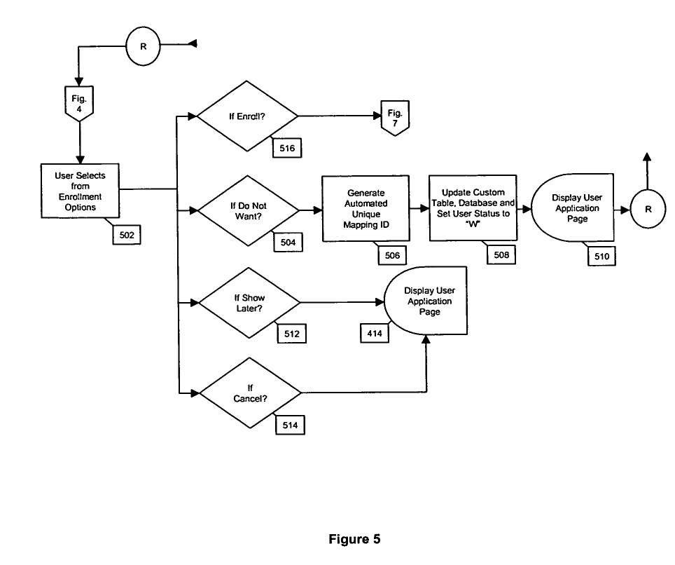

If the user attempting to gain access to an account on the on-line service provider registered within the system where the user information is not available in the custom table in the client infrastructure and does not have a physical token 448 then the enrollment page is displayed 450 as shown in FIG. 4 and the system processes this situation as shown in FIG. 5.

As may be seen in FIG. 5, a variety of enrollment options are offered to the user to select 502. If the user decides not to enroll 504, an automated unique mapping identification number also known as transaction control number (described below) 506 is generated. The custom table described below is updated 508 with the user status W and the fact that the user doesn't want a token is recorded. The benefits of enrolling and the option to enroll are displayed to the user 510 and the user is returned back to the beginning of the process (see R in FIG. 5). As may be seen in FIG. 4 when a user is recorded as not wanting a token 442, a count is made of the number of days since the user's desire to not sign up for a token is recorded. If a predetermined number of days has been exceeded 444, another enrollment page is displayed 446 for the user and the enrollment process proceeds as shown in FIG. 5. If the predetermined number of days has not been exceeded on the user application page 414 is displayed to a user with valid userid and password credential within the client infrastructure 12.

As shown in FIG. 5, if the user elects to be shown the enrollment options at a later time 512 or opts to cancel 514 the user application page 414 appears to a user with valid userid and password credential validated 404 within the client infrastructure 12.

However, should the user elect to enroll 516, the process proceeds as shown in FIG. 7. As shown in FIG. 7, the process begins by first confirming if the user already possesses a valid physical token 702 usable with the system and method 10 of the present invention. If the user does not already possess a physical token usable with the system and method 10 of the present invention, a request is made of the user to provide and capture a default password 704. This default password is used for later validation when the user status is set to either L or D for a lost or damaged physical token or when the authentication infrastructure is not available temporarily for unforeseen circumstances. The user provides the default password. Next, the agreement by the user to the terms and conditions associated with use of the system and method of the present invention is displayed 708 for the user. Here the user must decide whether or not to accept the agreement 710. If the user does not accept the terms and conditions of the agreement, the processing returns to 460 to the steps displayed in FIG. 5. If, however, the user accepts the terms and conditions, a determination is made if the user's information already appears in the custom table 714 described below. If the user's information does not appear in the custom table a unique automated transaction control number also referred to as mapping identification number (described below) 716 is generated and the information in the custom table is updated and the status of the user in the custom table is set to N as having a new physical token applied for 718. The information in the custom table, to include the unique transaction control number and information about the user, is sent to the authentication infrastructure 18 and the user's status is now listed as P, for in process, in the custom table 720 in the client infrastructure 12. When the information is received 722 by the authentication infrastructure 18, the enrollment of the user is processed 724 by the authentication infrastructure as detailed in FIG. 10. Once the enrollment process as detailed on FIG. 10 on the authentication infrastructure is completed, a packet of information is sent back 726 by the authentication infrastructure to the on-line service providers with reference to the unique automated transaction control number or mapping identification number to update the enrollment request within the client infrastructure. This information is received 728 by the on-line service provider and the status of the user is now listed as pending activation 730 or U in the custom table within the client infrastructure 12.

If it is determined that a new user does possess a physical token, then the user is displayed 732 a page to capture the authentication infrastructure 18 userid, also referred as authentication system user name of the user, and/or the information about the physical token with the user to obtain information about the physical token and a default password 732. The user provides information about the physical token and/or the authentication infrastructure user ID of the user and a default password 734. The default password will be used in future as explained above in [0051]. This information is then sent to the authentication servers for validation 736 as an enrollment validation request that is processed as shown in FIG. 9. As may be seen in FIG. 9, the enrollment request is sent 902 by the on-line provider to the authentication infrastructure 18 as an enrollment request validation. Once the enrollment request has been received 904 by the authentication infrastructure 18, the first determination is whether the request is being received from an on-line service provider authorized to use the system and method 10 of the present invention 906. If not, a fraud detection log entry is made 908. If, however, the request is being received from an on-line service provider authorized to use the system and method 10 of the present invention, then a determination is made if the user ID is valid 912. If the user ID is valid, the response is set to valid 918 and instruction is made to send an enrollment request 920. This request is received 922 by the client infrastructure 12. If the user ID is determined to be invalid, a determination is made if the information received describing the physical token is valid 914. If the information about the token is not valid, the response is set to invalid 916 and the enrollment request is processed by sending a response 920 to the client infrastructure 12 where the response for the authentication request is received 922. If, however, the token is determined to be valid, the response is set to valid 918, and the request is processed as described above in steps 920, 922. If the response 922 received from the authentication infrastructure 18 determined to be valid 738, the terms and conditions of the agreement to use the system and method of the present invention are displayed to the user 708 and the processing of the new user enrollment proceeds as described above. If, however, the response 922 is determined not to be valid 738 the user is sent back to step 734 for the user to provide correct userid of the authentication infrastructure or information about the physical token for enrollment. Once the enrollment process as detailed on FIG. 10 on the authentication infrastructure is completed, a packet of information is sent back 726 by the authentication infrastructure to the on-line service providers with reference to the unique automated transaction control number or mapping identification number to update the enrollment request with the client infrastructure. This information is received 728 by the on-line service provider and the status of the user is now listed as pending activation 730 or U in the custom table.

Referring again to FIG. 3B, within the database 16 attached to the application servers 14 in the client infrastructure 12, the custom table referred to above is created to support the interface of the user with the disclosed system and method 10 of the present invention and to integrate the multi-factor authentication services provided by the software applications running on the one or more authentication servers 20. The main fields within this custom table are described below.

Mapping ID Field—this field contains a unique transaction control number or mapping identification number which is generated and stored for an enrollment request. This unique transaction control number or mapping control number is used to track and communicate user information. The system and method 10 of the present invention makes use of this unique transaction control number without the on-line service provider having to reveal any user identifying information to include: userid with the on-line service provider, Social Security Number, Tax ID number, Date of Birth and other critical user identifying information. However, acceptance of the user is received in the notice and/or terms of service for sending the full name of the user, contact address where the physical tokens and other communications are to be sent by the authentication infrastructure, email address to communicate with the user with activation of the physical token and other information for use with the system and method of the present invention 10.

Bank User ID Field—This field captures and retains the userid of the user with the on-line service provider. The user id of the user with the on-line service provider used by the on-line service provider to identify a user accessing his/her account with the on-line provider. The userid information is never transmitted to the authentication infrastructure 18. The user identification information is used only to associate the user identification information with the unique transaction control number described above, with the authentication system user identification number, described below and the information about the physical token, also described below.

Authentication System User Identification Number Field—This field obtains information from the authentication server 20 of the authentication infrastructure 18 for creating the association of a user against the unique transaction control number, described above, and information obtained from the authentication server 20. The authentication system user identification number is unique and system generated by the authentication infrastructure 18. The authentication system user identification number is used for deployment of the physical token and for the authentication of the user. The authentication system user identification number in conjunction with information about the physical token can be used for authentication of the user. This number is invisible to the user but associated to the user in the system.

Authentication System User Name Field—This field is used to request enrollment in the system and method of the present invention where the user already has a physical token. Information will be fed to this field from the client infrastructure authentication server during the enrollment process 734 if the user provides the userid of the application infrastructure 14. The information is updated in the custom table for a user using the unique transaction control number described above. The authentication system user name is also the userid for the user to access the personal account information on the authentication infrastructure 18. Alternatively, this field is populated when the updated information is received 728 for a deployment of a new physical token.

Token Type Field—The system and method of the present invention allows for the issuance of different types of physical tokens. Examples of such physical tokens are those known as: RSA Secure ID, Vasco Digipasses and the like. Information about the physical token will be fed to this field from the authentication server using the unique transaction control number described above. The token type could also be biometric and others as described above. Information regarding the token type is fed to this field by the authentication server 20 as shown in steps 728, 730 in FIG. 7. This field can also be updated during the enrollment process 734 if the user provides information about the type of physical token.

Token Serial Number Field—Associated with each type of physical token is a serial number identifying an individual physical token. Information regarding the serial number of the physical token is fed to this field by the authentication server 728 & 730. This field can also be updated during the enrollment process 734 if the user provides the information about the physical token.

Password Field—The default password received from the user is captured and retained in this field. This default password is never passed to the authentication server 20. This default password is not the password used to access an account resident at the on-line service provider; rather, it is an additional password which is provided by the user and maintained only by the on-line service provider to be used for authentication if the authentication servers 20 are unavailable or when the user's physical token is either lost or damaged and the user status is set to L or D.

Status Field—As users may have one of multiple types of status, the current status of a user is maintained in this field. This status field is used to control navigation on the on-line service provider web application and to keep track of the authentication process for enrollment, activation and authentication of the user within the system and method 10 of the present invention.

Miscellaneous Fields—Other fields may be created to store such information as creation date, name of the creator, last date of update, and name of the last person updating.

As indicated in the description of the various fields above, when the user requests a new physical token or a request is made to use an existing physical token to gain access to a new on-line service provider, a unique transaction control number also known as mapping number id is generated and stored in the custom table. This unique transaction control number associates the information provided to the authentication infrastructure.

Once the authentication processes deploys the physical token, the authentication infrastructure 18 creates the authentication system user identification number and the authentication system user name. The authentication system user identification number is unique to the entire system and in invisible to the user. It is used to control the communication and authentication processes. The authentication system user name is generated and communicated to the user for the user to access his/her personal account information on the authentication infrastructure 18 or associates it to the enrollment request as shown in step 734 in FIG. 7. The application server provides a user identification number and information about the physical token to the data base attached to the application server 14 using the unique transaction control number or mapping identification number.

By use of the unique transaction control number and the authentication system user identification number, the on-line service provider need not release information such as the Social Security Number, Tax ID, Date of Birth of the user or the user's personal account password.

The database 22 in the authentication infrastructure 18 will maintain certain identifying information about the on-line service providers within the system and method 10 of the present invention. For example, the authentication database 22 will maintain the authentication system server identification number, the name of the on-line service provider, the identification number of the on-line service provider, the website address of the on-line service provider, the url address of the on-line service provider along with other information about the on-line service provider to provide enhanced security and validate communication with the registered on-line service providers using the system and method 10 of the present invention and the provision of authentication services to authenticated users.

The authentication database (one or more) 22 will also maintain certain identifying information about the user. For example, information such as the unique authentication system user identification number and authentication system user name, full name of the user, the user status, and contact information will be stored in the authentication infrastructure data base 22. The user status in the authentication infrastructure 18 need not be same as the user status in the client infrastructure 12.

Token identifying information will also be stored in the data base 22 associated with all the authentication servers hosted to provide the authentication service. Such information will include the physical token type, the physical token serial number, the physical token issue date, the physical token expiration date and the physical token status and other information about the physical token.

The authentication system user identification number and the physical token mapping information will be stored along with the unique transaction control number as received from various on-line service providers.

An authentication log will also be maintained to provide an authentication and support audit if needed.

By use of the authentication system and method 10 of the present invention, when users initiate the process of going to a computer terminal to enter their account at the website of an on-line service provider, the user will enter the user identification information with the on-line service provider and the multi-factor information needed to engage the system and method 10 of the present invention. Such multi-factor information is sent to the authentication infrastructure 18 when the services are available and only when the status of the user is recorded as being active, status A in the custom table, for authentication.

The application server 14 will validate the identifying information from the user and the user's password in the customary manner and then request additional information provided by the authentication server 20. During the entry of the additional information the custom table is used as described above. Once the information has been received it is sent to the authentication server 20 for validation.

Once the request for authentication validation is received by the authentication server 20, the request is validated and the needed information for authenticating the user is extracted and the external information such as the random number being used at the time of validation is called up. All of this information must be matched for the validation process to continue.

The result of the validation process; be it valid, invalid or error will be attached to the validation request and communicated back to the on-line service providers which then interprets and determines if the user access is to be granted or not.

If the validation process is successful, the user is granted access to his/her account at the on-line service provider. If the authentication is invalid or in error, the user will be required to provide the log-on credentials again.

As indicated above, other items in the possession of the user such as biometric information, software tokens, smart cards, public key authentication and the like may be used in the place of a physical token without departing from the scope of the present invention. In the case of the use of biometric information, the deployment of a physical token will include the steps of the user accessing the authentication infrastructure and providing the biometric information to the authentication infrastructure for future authentication needs. The biometric information from the user will be stored in one central highly secured location with additional security built in to protect the biometric data and perform authentication using the processes described above. Each on-line service provider will not be required to maintain the biometric information of the user in their database.

Those of ordinary skill in the art will understand that use of the disclosed system and method will provide numerous advantages which allow multiple on-line service providers to use a single authentication system to assure greater security for user's accounts. Such advantages include:

Integration and consolidation of the authentication systems for multiple on-line service providers at one location requiring a user to carry only one token for multiple on-line service provider authentication;

Compatibility with the multiple different types of security systems, hardware, technology platform, operating systems, application systems used by multiple on-line service providers;

Reduction in the cost of multi-factor authentication for on-line service providers;

Reduction in the risk of unwanted on-line information soliciting or “phishing”;

Increased trust by both on-line service providers and users in the authentication system guarding access to personal account information;

Providing an option for a user to select those on-line service providers to whom access can be gained using the disclosed system and method;

Shutting down the account access process upon the sequential detection of unauthorized attempts to gain access to user account at one or more on-line service provider;

Deployability to multiple computer terminals using different programming languages;

Increasing user convenience as the user is required to possess only one physical token for authentication to multiple on-line providers;

Identifying a user by phone if a physical token is used and the random number generated on the physical token matches with the numbers provided to the client infrastructure by the authentication infrastructure.

While the system and method of the present invention has been disclosed in terms of its preferred embodiment, those of ordinary skill in the art will understand that the additional embodiments will become apparent. Such additional embodiments shall be included within the scope and meaning of the appended claims.

What is claimed is:

1. A system for authenticating the identity of a user of the services provided by one or more on-line service providers, said system comprising:
an item of information known by the user, said item of information providing a first identification factor;
an object in the possession of the user, said object providing a second identification factor;
a client infrastructure for first receiving and then transmitting said first and second identification factors to an authentication infrastructure for:
verifying the accuracy of said first and second identification factors;
generating a message to one of the one or more on-line service providers in said client infrastructure that said first and second identification factors have been authenticated;
connecting the user to the on-line service provider;
whereby the users need only one of said item of information and only one of said item object in possession to gain individual access to the one or more on-line service providers.

2. The system as identified in claim 1 wherein said object in the possession of the user is selected from a group including: biometric measurement, software tokens, smart cards, and public key authentication.

3. The system as identified in claim 1 wherein said client infrastructure includes one or more application computer servers and said authentication infrastructure includes one or more authentication computer servers.

4. The system as defined in claim 3 wherein data obtained from the user and data obtained from said application computer server is organized into a custom table stored in a data base in said client infrastructure.

5. The system as defined in claim 4 wherein one or more of the data items placed into said custom table are selected from a group including: a transaction control number, an authentication system identification number, and an authentication system identification name.

6. A method for authenticating the rights of a single user to one or more on-line service providers, said method comprising the steps of:
providing the user with an item of information known only to the user, said item of information known only to the user being a first identification factor;
providing the an object to the possession of the user, said object in the possession of the user being a second identification factor;
receiving said first identification factor and said second identification factor at a computer terminal;
transmitting said first and second identification factors from said computer terminal to an authentication infrastructure;
verifying the accuracy of said first and said second identification factors;
generating a message to a selected one of the one or more on-line service providers that said first and second identification factors have been verified;
connecting the user to said selected on-line service provider.

7. The method as defined in claim 6 wherein the object in the possession of the user is a physical token.

8. The method as defined in claim 7 further including the step of mapping information regarding said physical token to on-line service providers.

9. The method as defined in claim 7 further including the step of receiving user information from other on line service providers to register a new user.

10. The method as defined in claim 7 further including the step of using information from other on-line service providers to register new mapping with an existing physical token.

11. The method as defined in claim 6 further including the step of suspending authentication when fraud is detected.

12. The method as defined in claim 7 further including the step of registering a user who is not in possession of a physical token.

13. The method as defined in claim 7 further including the step of transmitting updating information to mapped on-line service providers when information regarding a physical token is updated due to loss or damage of the token.

14. The method as defined in claim 7 further including the step of mapping a directory of all authorized on-line service providers to a single physical token.

15. The method as defined in claim 6 further including the step of validating the use of first identification factor and said second identification factor to assure that the same identification factors are not used sequentially for validation.

16. The method as defined in claim 6 further including the step of controlling the on-line service provider's application navigation depending on the user status.

17. The method as defined in claim 7 further including the step of validating the enrollment request for existing users within the system requesting use of an existing physical token with other on-line service providers.

18. The method as defined in claim 6 further including the step of integrating multiple on-line providers with the authentication infrastructure without sharing the critical identifying information of the user selected from a group including: Social Security Number, Tax ID, Date of Birth, and UserID.

19. A method for authenticating the rights of a single user to a set of one or more on-line service providers, said method comprising the steps of:
providing the user with an item of information known only to the user, said item of information known only to the user being a first identification factor;
providing the user with a physical token generating a random number, said random number being a second identification factor;
transmitting said first identification factor and said second identification factor to a customer service representative of the on-line service provider whereby said customer service representative may verify the authenticity of said first and said second identification factors using an authentication infrastructure;
generating a message to the set of on-line service providers of the verification of the authenticity of said first and said second identification factors;
connecting the user to a selected on-line service provider from the set of on-line service providers.

20. The method as defined in claim 19 wherein said authentication infrastructure will supply said customer service representative of the on-line service provider with said random number.
